(19) United States
(12) Patent Application Publication
(10) Pub. No.: US 2016/0182955 A1
(43) Pub. Date: Jun. 23, 2016

(54) METHODS AND SYSTEMS FOR RECOMMENDING MEDIA ASSETS

(71) Applicant: Rovi Guides, Inc., Santa Clara, CA (US)

(72) Inventors: Walter R. Klappert, Los Angeles, CA (US); Michael McCarty, Agoura Hills, CA (US)

(21) Appl. No.: 14/581,403

(22) Filed: Dec. 23, 2014

(51) Int. Cl. H04N 21/466; H04N 21/442

(52) U.S. Cl. CPC H04N 21/4668; H04N 21/442; H04N 21/4662

(57) ABSTRACT

Methods and systems are disclosed herein for a media guidance application that determines whether or not emotional displays by participants in a media asset are genuine (e.g., based on biometric measurements received for the participant during an emotional display), and based on that determination, recommends the media asset to a user.

### BACKGROUND

In conventional systems, the user is not able to accurately determine whether participants in a media asset actually feel what they claim to feel. For example, a user may watch a reality television show and view a participant in the show crying. Despite viewing the emotional display, the user will not be able to determine whether or not the participant actually feels sad. Users like to see genuine emotional displays because it creates a more exciting viewing experience, but currently they have no way to accurately determine if a given emotional display is genuine.

Furthermore, the user is not able to determine how the emotional display of the media asset participants compare to the emotions that the user would feel in a similar situation. For example, the user may not be able to tell if the participant in the reality television show is acting in a similar manner to the user if the user was in a similar situation, and, hence, the user cannot tell if the participant is displaying genuine or embellished emotions. Finally, conventional systems do not recommend media assets to the user based on the correspondence between the real emotions of the media asset participants and the emotions of non-participants in similar situations. For example, the user may only want recommendations from a media guidance application for media assets that contain participants who accurately depict their real emotions.

### SUMMARY

Accordingly, methods and systems are disclosed herein for a media guidance application that determines whether or not emotional displays by participants in a media asset are genuine, and if so, recommends those media assets to a user. For example, users may enjoy and/or prefer media assets in which participants exhibit genuine emotional displays (as opposed to scripted or acted emotional displays). To determine whether or not an emotional display is genuine, the media guidance may recommend media assets to users based on biometric measurements indicative of the emotions of participants in media assets. For example, the media guidance applications may receive biometric measurements of a participant in media assets while that participant is exhibiting an emotional display, where the biometric measurements are indicative of the participants' emotions. Based on the biometric measurements, the media guidance application may determine whether or not the emotional display of the participant is genuine. Based on this determination, the media guidance application can recommend assets with genuine emotional displays to the user. This allows the user to consume media assets that the user is likely to find most interesting.

In some aspects, the media guidance application may, using control circuitry, receive biometric measurements (e.g. pulse, blood pressure, body temperature) for a media asset participant (e.g., an actor in a movie or a contestant in a reality television show) during an emotional display. The media guidance application may then determine an emotion that corresponds to the emotional display (e.g., sorrow).

The media guidance application may cross-reference the participant's biometric measurements with a database (e.g., located on storage circuitry) listing the biometric measurements of non-participants (e.g., viewers consuming the media asset) experiencing the emotion to determine whether the biometric measurement corresponds to the biometric measurements for non-participants experiencing the emotion. For example, the media guidance application may cross-reference the biometric measurements of non-participants during a display of happiness to the biometric measurements of the participant during the participant's emotional display of happiness, and based on this cross-referencing the media guidance application may determine that the emotional display of the participant is genuine.

If the biometric measurements of the participant corresponds to the biometric measurements of the non-participants (e.g., the participant's biometric measurements correspond to the biometric measurements of non-participants who are feeling sorrow), the media guidance application may recommend the media asset (e.g., reality television show) to the user. For example, the media guidance application may determine that a user prefers a genuine display of emotion as opposed to scripted or embellished emotional display. Accordingly, the media guidance application may only recommend media assets with genuine emotional displays.

In some embodiments, biometric measurements for non-participants experiencing the emotion include biometric measurements for the user while the user is experiencing the emotion. For example, in order to determine whether or not an emotional display of the participant is genuine, the media guidance may compare the biometric measurements of the participant during the emotion to the biometric measurements of the user while the user is experiencing the same emotion.

In some embodiments, the media guidance application may not recommend the media asset to the user upon determining that the biometric measurements for the participant do not correspond to the biometric measurements for the non-participants. For example, a media guidance application may determine that a reality television program has a participant whose biometric measurements indicate her display of happiness is not genuine. Hence, the media guidance application will not recommend this reality television program to the user since the user is unlikely to want to watch a reality television program with fake emotional displays.

In some embodiments, the biometric measurements for the non-participants may include the biometric measurements for the participant in the past. For example, the media guidance application may compare the biometric measurements of a participant in a reality television show during a fight this week, to the biometric measurements of the participant during a fight in a previous episode that was recorded in a previous week. If the biometric measurements correspond, then the participant's emotional display is likely to be genuine.

In some embodiments, determining if the biometric measurements of the participant and the non-participants corresponds may comprise, using control circuitry, averaging the biometric measurements of the non-participants (e.g., determining the average biometric measurements of viewers experiencing happiness); determining a deviation between the biometric measurement and the average non-participant biometric measurement (e.g., determining the difference between the biometric measurements of a movie actor portraying happiness and the average biometric measurements of viewers experiencing happiness); and finally, comparing the deviation to a threshold deviation to determine whether to recommend the media asset (e.g., comparing the difference between the two sets of biometric measurements to a threshold value, and recommending the movie to a user if the two sets are more similar than the threshold value requires). The threshold deviation represents the maximum deviation that a participant's biometric measurements can have while still corresponding to the non-participants' biometric measurements.

In some embodiments, the intensity of the emotional display may be determined and used to rank the media asset (e.g., a ranked list of news broadcasters' emotions while reporting different news events). The user may use the ranked media assets to find out which media assets contain the most intense emotional displays and only consume those media assets. This allows the user to consume only the media assets that are most dramatic, and, hence, most likely to be interesting to the user.

In some embodiments, a parental lock may be set on the media asset based on the biometric measurement. For example, if a talk show has guests whose biometric measurements indicate they feel emotions of hate and anger, the talk show may be placed under a parental lock to prevent young children from being exposed to the show. This allows parents to ensure their children will not be unintentionally exposed to angry or hateful emotional displays. The parents can make sure their children are only exposed to age-appropriate media content by taking into account the emotional displays of the media asset participants.

In some embodiments, the media guidance application may generate for display an indication of the biometric measurements of the participant in the media asset. For example, a “sadness meter” might display a level of sadness being experienced by a participant in a reality television show. This sadness meter allows the user to quickly and easily decide whether the current media asset is of interest to the user or not.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is an illustrative example of a display generated by a media guidance application in accordance with some embodiments of the disclosure, with an indication of the biometric measurements, corresponding emotion, and recommendation;

FIG. 6 is a flowchart of illustrative steps for recommending a media asset in accordance with some embodiments of the disclosure; and

FIG. 7 is a flowchart of illustrative steps for generating a recommendation of a media asset based on the emotional authenticity and intensity displayed in accordance with some embodiments of the disclosure.

### DETAILED DESCRIPTION OF THE DRAWINGS

Methods and systems are disclosed herein for a media guidance application that determines whether or not emotional displays by participants in a media asset are genuine, and if so, recommends those media assets to a user. Therefore, the media guidance application may be able to recommend to users media assets that feature emotional displays that may be most interesting to users. As referred to herein, a “media guidance application” or “guidance application” is an application that allows a user to access media content.

Media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As referred to herein, “participants” in a media asset includes anyone associated with a production of a media asset. Participants may include actors, directors, producers, writers, musicians, and workers for a movie, television programming, or internet programming. Participants may also include contestants or candidates in reality television shows. Participants may also include players in a live or taped sports event. Participants may also include audience members for a television show or a sports event. Participants may also include writers, editors and illustrators for textual media assets. Participants may also include artists associated with a painting, stage performance or musical performance. Participants may also include bloggers, photographers and reviewers of media assets.

As referred to herein, “non-participants” includes anyone that is not a participant. Non-participants may include users of the media guidance application. Non-participants may also include consumers of a media asset, for example, a television or movie audience. Non-participants may also include a live audience during a sporting event. Non-participants may also include members of the user's social network or demographic group. Non-participants may also include focus groups for media assets.

Biometric measurements for non-participants may be obtained from facilities like research labs or hospitals which collect and store such data. Biometric measurements for non-participants may also be obtained from sources like health-tracking mobile applications and wireless monitors which non-participants may use. Biometric measurements may also be obtained from media content providers who may have biometric measurements for focus groups. Biometric measurements may also be obtained from survey results where non-participants may be asked to provide their information. In some embodiments, the biometric measurements may be collected in an anonymized format to protect sensitive non-participant information. In some embodiments, the biometric measurements may be associated with information identifying non-participants, and this identifying information may be used to determine social links between the user of the media guidance application and the non-participants. This may enable a user to filter the non-participant biometric measurements used to create media recommendations by social links. For example, a user may choose to have the media guidance application only consider biometric measurements of the user's family to create media recommendations.

As referred to herein, “events” include any segment of a media asset that is distinguishable from other segments of the media asset. Events may include an interaction involving more than one participant in a media asset, for example, a fight, a conversation, or a date. Events may also include a fictional scene in a movie. Events may also include individual plays or actions within a live sporting event. Events may also include a segment of a news report.

As referred to herein, “emotion” refers to a qualitative or quantitative assessment of a state of mind deriving from one's circumstances, mood, or relationships with others. For example, the media guidance application may be able to classify biometric measurements as depicting emotions like happiness, sadness, anger, and hatred.

As referred to herein, “emotional display” refers to an outward display of emotion. An emotional display may include indicating happiness by smiling or laughing. An emotional display may also include indicating sadness by crying, tearing up, or becoming silent. An emotional display may also include indicating anger by yelling, screaming, punching, casting insults at other participants, or breaking objects. An emotional display may be intentional or unintentional. An emotional display may be an expression or an action.

As used herein, “biometric measurement” refers to distinctive, measurable characteristics used to label and describe the psychological or physiological condition of a user. For example, biometric measurements that may be received, managed, monitored, and/or shared by a media guidance application may include psychological characteristics related to the level of concentration, emotional state, mood, and/or pattern of behavior of a person, including, but not limited to, typing rhythm, gait, frequency of social interactions, voice tones, etc., or may include physiological characteristics related to the status and/or shape of the body such as height, weight, medical condition(s), heart rate, blood pressure, fingerprint, body mass index, glucose level, face description, DNA, palm print, hand geometry, iris, retina, odor/scent, and/or any other mechanical, physical, and biochemical functions of a user, his/her organs, and the cells of which they are composed.

Biometric measurements may be determined by measurement devices. As referred to herein, “measurement devices” may include devices capable of determining at least one biometric measurement. Measurement devices may include heart rate monitors, pedometers, thermometers, microphones, weighing machines, length-measuring tapes, blood testing kits, fingerprint sensors, DNA kits or eye scanners. In some embodiments, measurement devices may be attached to a participant or non-participant. For example, a participant in a reality television show may always wear a skin temperature sensor. In another example, a user of the media guidance application may use a pedometer that attaches to the user's clothes. In some embodiments, measurement devices may be able to transmit the biometric measurements in real time. For example, a heart rate monitor may be able to continuously transmit its readings using the internet. In some embodiments, measurement devices may comprise storage circuitry to store the biometric measurements. For example, a non-wireless heart rate monitor worn by an athlete may store the athlete's heart rate during a game.

In some embodiments, the media guidance application may use a content recognition module to identify a particular emotion corresponding to an emotion display and/or whether or not an emotional display is occurring. For example, the content recognition module may use object recognition techniques such as edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique. For example, the media application may receive data in the form of a video of the participant. The video may include a series of frames. For each frame of the video, the media application may use a content recognition module or algorithm to determine whether or not a participant is having an emotional display and/or an emotion that corresponds to the emotional display in each frame. In some embodiments, the media guidance application's content recognition module may associate certain biometric measurements to certain emotional displays. For example, displays of crying may be associated with the emotion of sadness. In some embodiments, the biometric measurements may comprise tags that indicate the emotional display taking place. For example, biometric measurements of a reality television contestant yelling may be tagged with information indicating an emotional display of anger is taking place. In some embodiments, the user of the media guidance application may provide information identifying the emotional display. For example, a user wearing a heart-rate monitor and watching a scary movie may indicate to the media guidance application that the user's current heart rate is associated with a feeling of fear.

In some embodiments, the content recognition module or algorithm may also include speech recognition techniques, including, but not limited to, Hidden Markov Models, dynamic time warping, and/or neural networks (as described above) to translate spoken words into text and/or processing audio data. The content recognition module may also combine multiple techniques to support voice controls.

In addition, the media application may use multiple types of optical character recognition and/or fuzzy logic, for example, when processing keyword(s) retrieved from data (e.g., textual data, translated audio data, user inputs, etc.) describing a user (or when cross-referencing various types of data in databases). For example, if the particular data received is textual data, using fuzzy logic, the media application (e.g., via a content recognition module or algorithm incorporated into, or accessible by, the media application) may determine two fields and/or values to be identical even though the substance of the data or value (e.g., two different spellings) is not identical.

In some embodiments, the media guidance application may receive biometric measurements for participants in a media asset in real time. For example, biometric measurements of a football team's players may be received by the media guidance application during a live game. The biometric measurements may be received because the football players may be wearing heart monitors with the ability to wirelessly transmit the players' heart rate. In some embodiments, the media guidance application may receive, from media source 416 or 418, biometric measurements for participants in a media asset after an event depicted in the media asset has occurred. For example, a reality television show may be recorded in advance of its broadcast. The media guidance application may receive the biometric measurements for participants in the reality television show for storage in the storage circuitry after the events depicted in the television show have already occurred and been taped.

In some embodiments, the media guidance application recommends media assets based on a subset of a plurality of emotional displays. For example, the media guidance application may provide recommendations based only on winning celebrations during soccer games. In this example, the media guidance application will recommend soccer games to the user only if the winning celebrations during the soccer games correspond to the winning celebrations of non-participants. In this example, the media guidance application will not base its recommendation on reactions of players upon losing. The quality of losing displays will be irrelevant to the media guidance application as the recommendations will only be based upon the quality of the winning displays. In another example, the media guidance application may recommend media assets based on a correspondence between the intensity of happiness displays of a media asset's participants and non-participants. In this example, the media guidance application will not base its recommendation based on any correspondence or lack thereof between the intensity of the fear displayed by a media asset's participants and non-participants.

In some embodiments, the media guidance application may only consider the quality of emotional displays, instead of their quantity. For example, a user may wish to watch soccer games with extremely exuberant winning celebrations, even if there are only few celebrations in a given game. The media guidance application will recommend soccer games to the user that have a few very emotional winning celebrations, instead of many routine winning celebrations.

In some embodiments, the media guidance application may restrict the recommended media assets to a certain type of asset. As referred to herein, “type of asset” refers to an asset category like books, television shows, movies, music, websites, or pictures. For example, a parent may want their child to spend less time in front of a screen and, hence, instruct the media guidance application to only provide recommendations of books for a child. Hence, the media guidance application will not provide recommendations of television shows or movies to the child, while providing recommendations of books with emotional displays the child might find interesting. In this situation, the child will be satisfied to be recommended content that the child finds interesting, while the parent will be satisfied that the child's screen time is being reduced.

In some embodiments, a parental lock may be set on the media asset based on the biometric measurements. For example, a parent may set a parental lock that causes the media guidance application to recommend media assets with intense emotions of happiness to a young child, while blocking media assets with intense feelings of fear. This would allow the parent to ensure that the child is only recommended age-appropriate shows that will not frighten the child. In some embodiments, the parental control lock may be set based upon intensities of emotional displays. For example, a parent may block intense feelings of fear from being recommended to a child while allowing mild feelings of fear. This would allow the child to watch age-appropriate, mildly frightening shows, while ensuring the child is not recommended gory movies.

In some embodiments, the media guidance application may not recommend the media asset to the user upon determining that the biometric measurements for the participant do not correspond to the biometric measurements for the non-participants. The lack of correspondence may indicate that the media asset participant is not displaying genuine emotions, and users may not find media assets with fake emotional displays interesting. For example, a media guidance application may not recommend to a user a talk show with a host whose biometric measurements do not correspond to that of the viewers, as the user may find such a talk show host's emotions fake and unappealing.

In some embodiments, the biometric measurements for the non-participants may include the biometric measurements for the participant in the past. For example, the media guidance application may compare the biometric measurements for an actor in a newly released movie to the biometric measurements for the actor during a previous blockbuster hit. If the actor's biometric measurements have stayed the same, the media guidance application may recommend the movie to the user. In this example, the user may enjoy the movie as the actor's performance may be similar to his performance in the previous successful blockbuster. Additionally, if the actor's biometric measurements have changed to become more intense, the media guidance application may still recommend the media asset to the user as the user may find an even more intense display of emotion causes this movie to be even more interesting than the previous blockbuster. On the other hand, if the actor's biometric measurements have changed to become less intense, then the media guidance system may not recommend the media asset to the user as the user may not find an unemotional movie interesting to watch.

In some embodiments, the determination of the biometric measurements of the participant and the non-participants may comprise using control circuitry, averaging the biometric measurements of the non-participants, determining a deviation between the participant's biometric measurements and the average non-participant biometric measurements, and comparing the deviation to a threshold deviation to determine whether to recommend the media asset. The media guidance application may average the biometric measurements of only a subset of non-participants. For example, the subset of non-participants may include the user's friends or family. The subset of non-participants may also include a demographic like young adults, or people who live on farms. The threshold deviation may be set by the user, and defines a maximum amount that the biometric measurements of the participants may deviate from the biometric measurements of the non-participant for a given emotional display.

The threshold deviation may initially be set by the media guidance application to an appropriate amount, and may be later adjusted by the user to get more relevant recommendations. A low threshold deviation value will cause media assets with a very small deviation between participants' and non-participants' biometric measurements to be recommended. This small deviation indicates that the biometric measurements of the participants and non-participants are similar. A high threshold deviation value will allow media assets with high deviation between participants' and non-participants' biometric measurements to be recommended. This will allow media assets to be recommended even if there are large differences between the biometric measurements for the participants and the non-participants. The threshold deviation may be measured in any appropriate units. For example, the media guidance application may compare an educational video host's biometric measurements while teaching math to the average school teacher's biometric measurements. A low threshold deviation value may have been set by a user to only find videos where the host has similar biometric measurements to school-teachers, as the user finds it easiest to learn from videos where the host reminds the user of school teachers. Hence, the media guidance application may only recommend a video to the user if the educational video host has similar biometric measurements as a school teacher. These biometric measurements may indicate that the host has characteristics of cheerfulness, patience and an absence of a monotone, qualities which together combine to create a better learning environment for the user.

In some embodiments, the user may be able to set the threshold used in the determination of whether the biometric measurements of the participant and the non-participants correspond. For example, the user may want to only watch television dramas where the actors display emotion in a manner almost identical to a non-participant; in this case, the user may set a very low deviation threshold. A low deviation threshold would mean that the media guidance application only recommends assets where there are very small deviations between the participants' and the non-participants' biometric measurements. The threshold value would cause the media guidance application to not recommend any media assets with deviations higher than the threshold deviation.

In some embodiments, the user may choose to set different threshold deviations for different emotional displays. For example, the user may set a high threshold deviation for displays of happiness, because the user enjoys watching both genuine and non-genuine displays of happiness. The user may simultaneously set a low threshold deviation for displays of anger, because the user only wishes to watch genuine displays of anger. In this example, the media guidance application will recommend media assets to the user which have a wide variety of displays of happiness, but only genuine displays of anger.

In some embodiments, the intensity of the emotional display may be determined, using control circuitry, and used to rank the media asset. For example, a media guidance application may rank the different seasons of a weight-loss program based on the degree of the happiness of the participants at the end of each season. These rankings may then be displayed to the user so the user can choose to watch a season of the weight-loss program based on which season will provide the most intense emotional displays, and, hence, the most enjoyment.

As referred to herein, “intensity” of the emotional display refers to the strength of the emotional display. The strength may be determined by the control circuitry through considering the values of the various received biometric measurements and their correspondences to each other. For example, an intense feeling of fear may be determined by the media guidance application if a first media asset participant's biometric measurements include a loud scream and a fast heartbeat. This feeling would be considered intense as the media guidance application would determine that non-participants only gasp when feeling fear, which is a much less intense reaction than the first media asset participant showed. On the other hand, the media guidance application would determine that a second media asset participant's feeling of fear is not intense if the second participant merely blinks while the first participant is screaming.

In some embodiments, an indication of the biometric measurements of the participant in the media asset may be generated by the control circuitry. As referred to herein, an “indication” may include an icon, a rating, a score, a rank, text, picture, sound, vibration, or any combination of the foregoing. Any visual, audio or physical indication may be generated on user television equipment.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

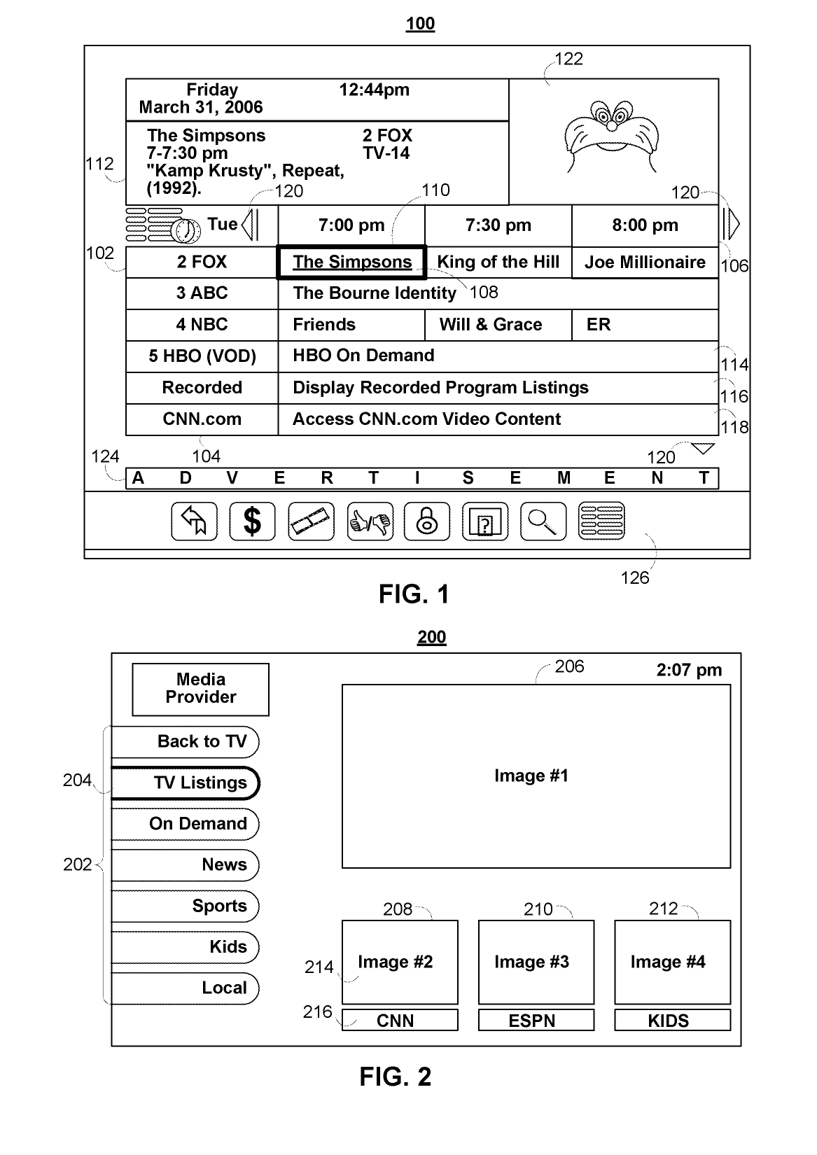

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

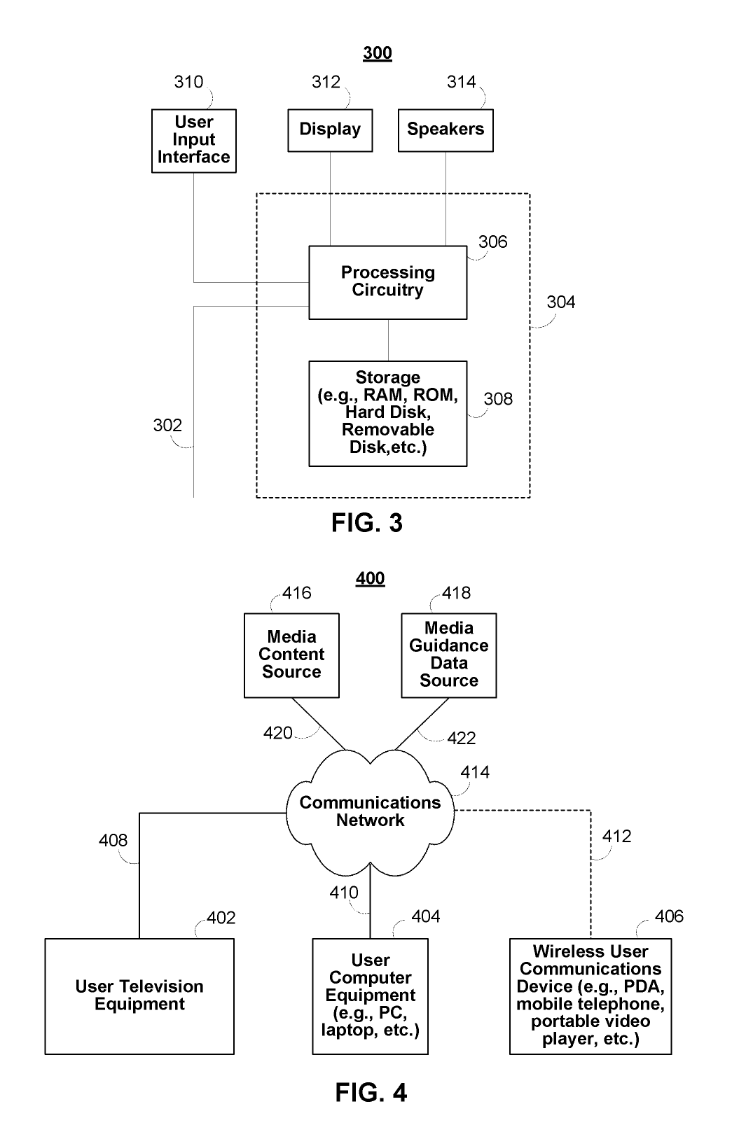

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

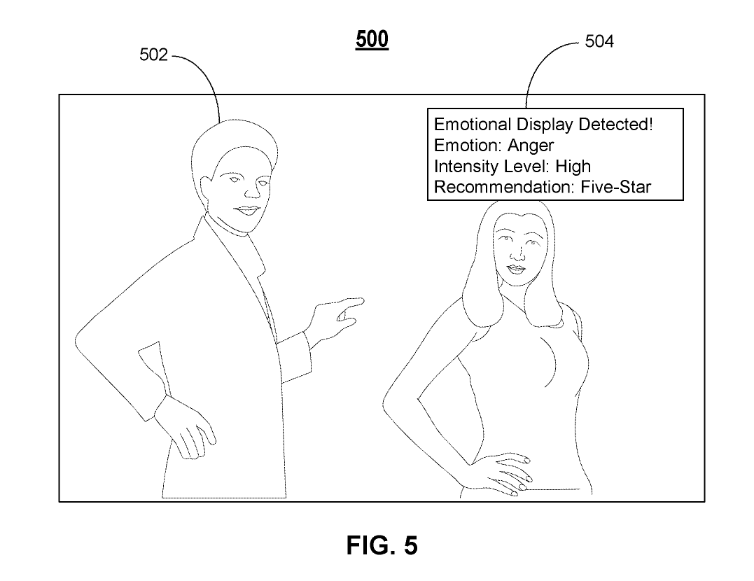

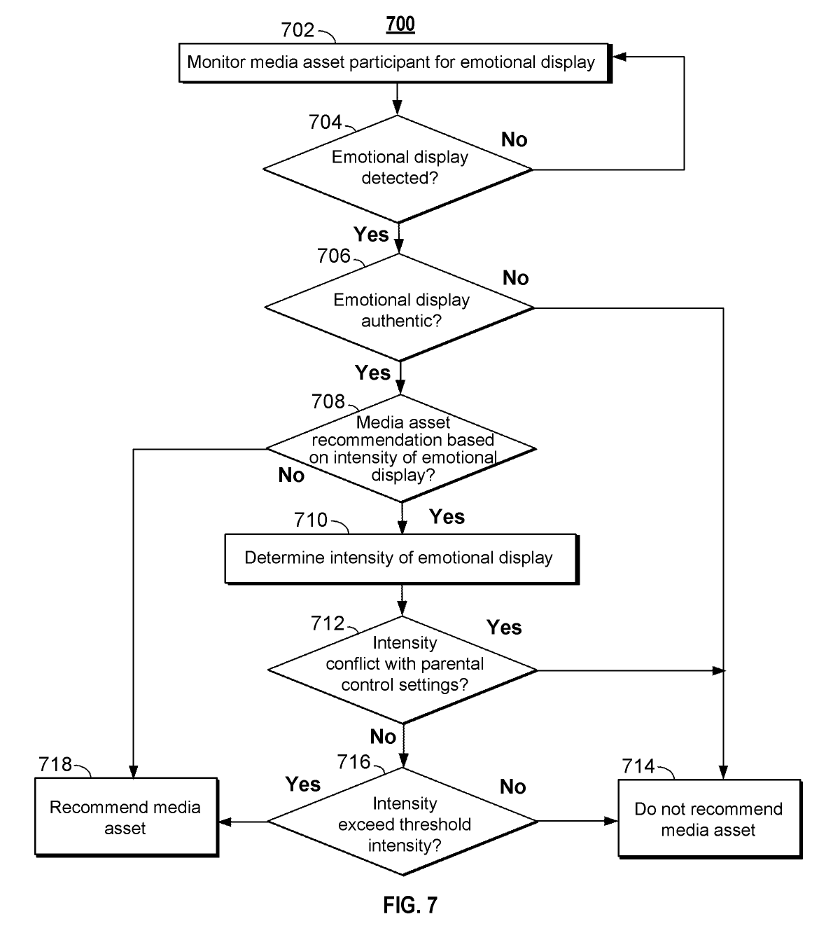

FIG. 5 is an illustrative example of a display generated by a media guidance application in accordance with some embodiments of the disclosure. The display 500 depicts a media asset (e.g., a television show). Participant 502 is displaying anger in the media asset. The media guidance application may receive, through communications network 414 from media sources 416 or 418, the participant's 502 biometric measurements during the display of anger, and may use control circuitry 304 to detect that the current biometric measurements correspond to an emotion of anger. The media guidance system may use the steps described in FIG. 7 to determine the intensity of the participant's 502 anger. The media guidance system may create a recommendation for the user to watch this media asset based on the correspondence between the participant's 502 biometric measurements and non-participants' biometric measurements.

Indicator 504 is displayed on screen in response to the participant's 502 display of anger. An indicator may take many forms, and this is just one exemplary example. The first line of indicator 504 (“Emotional display detected!”) contains an alert that an emotional display has been detected, referring to the anger of participant 502. The second line of indicator 504 (“Emotion: Anger”) identifies the emotion (Anger), as determined by the control circuitry 304 of the media guidance application, of the emotion being displayed by the participant 502. The third line of indicator 504 contains an intensity level (“Intensity Level: High”), as determined by the control circuitry 304 of the media guidance application, of the emotion being displayed by the participant. The fourth line of indicator 504 contains a recommendation (“Recommendation: Five-Star”) for a user to watch this media asset, as determined by the control circuitry 304 of the media guidance application. The indicator 504 may contain more or less information than displayed in FIG. 5. For example, the indicator 504 may only contain a subset of the information currently shown in FIG. 5.

In some embodiments, more than one indicator may be displayed to show information related to emotional displays of more than one participant in the media assets. For example, a second indicator may be displayed in the top left corner of the screen shown in FIG. 5 that corresponds to the female participant's emotional display.

In some embodiments, indicator 504 may comprise a sound. For example, the volume, pitch, or contents of the sound may indicate information about the information display. In some embodiments, indicator 504 may comprise a physical alert. For example, if the media guidance application is implemented on a cell phone, the cell phone may vibrate to indicate emotional displays.

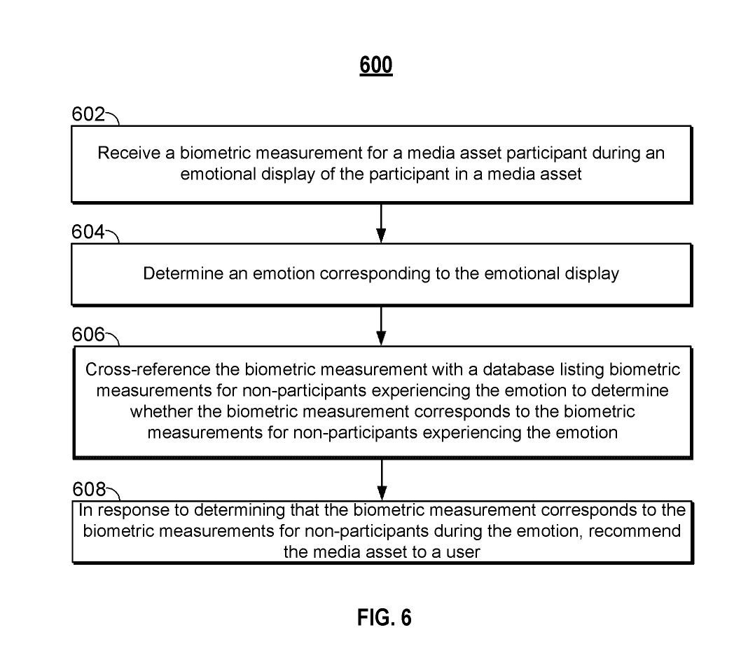

FIG. 6 is a flowchart of illustrative steps for recommending a media asset in accordance with some embodiments of the disclosure. It should be noted that the process 600 or any step thereof could be performed on, or provided by, any of the devices shown in FIGS. 3 and 4. For example, process 600 may be executed by control circuitry 304 as instructed by the media guidance application or a module thereof in order to provide media asset recommendations. In addition, one or more steps of process 600 may be incorporated into, or combined with, one or more steps of any other process or embodiment.

At step 602, the media guidance application receives a biometric measurement for a media asset participant during an emotional display of the participant in the media asset. The biometric measurement may be received through communications network 414 from media source 416 or 418. In some embodiments, the biometric measurements may be transmitted as metadata or tags along with the media assets themselves. In some embodiments, the biometric measurements may be stored in the storage circuitry 308 of the media guidance application at a time prior to transmission of the media asset. For example, the user may purchase information containing biometric information about a media asset prior to consuming the media asset, and this information is stored until a recommendation needs to be generated for the user. The biometric measurements may themselves contain tags identifying the type of measurement (pulse, blood pressure, heart rate), the participant whom the measurements belong to, and when they were taken. In some embodiments, the media guidance application may simultaneously receive a plurality of biometric measurements corresponding to the same media asset participant. In some embodiments, the media guidance application may receive a plurality of biometric measurements corresponding to a plurality of participants. The media guidance application may combine the biometric measurements of a plurality of participants to create a single group of biometric measurements. For example, biometric measurements may be received for all players on a hockey team during a game. The media guidance application may average the biometric measurements for all players to create a set of biometric measurements corresponding to the entire team. These biometric measurements for the entire team may be then used to determine the hockey team's emotion and recommend the hockey game to the user if the team's emotion is determined to be genuine. In some embodiments, the media guidance application may recommend a media asset based on the biometric measurements of a plurality of participants. For example, the media guidance application may receive biometric measurements for both players in a tennis game. The media guidance application may recommend the tennis game to the user only if the emotions associated with both players are determined to be genuine.

At step 604, the media guidance application determines an emotion corresponding to the emotional display. For example, the media guidance application, using control circuitry 304, may process the received biometric measurements and determine an emotion corresponding to the biometric measurements. In some embodiments, the media guidance application may use storage circuitry 308 to store templates of standard biometric measurements that correspond to particular emotions that can be compared to the incoming biometric measurements. For example, storage circuitry 308 may contain a template of anger that defines anger as including loud voices, aggressive postures, and high blood pressure. In some embodiments, the media asset may contain tags identifying the emotions associated with the media asset's participants at different times. In some embodiments, the media guidance application may use metadata associated with the media asset to determine the participant emotion. For example, the media guidance application may use a movie's genre to classify biometric measurements (e.g., corresponding to high blood pressure) for participants in a scary movie as the emotion of fear, whereas the same biometric measurements for participants in an action movie may be classified as the emotion of excitement. In some embodiments, the media guidance application may compare the participant's biometric measurements to biometric measurements of non-participants experiencing various emotions to determine which emotion is most similar to the emotion that the participant is displaying. For example, the media guidance application may receive information in which the biometric measurements of non-participants were determined and the non-participants were asked to identify an emotion being experienced. The data obtained from the non-participants may then be averaged and compared to biometric measurements for participants during emotional displays. If the biometric measurements of the participants match the average biometric measurements for a non-participant, the media guidance application may determine the emotion with which the matching biometric measurement is associated.

In some embodiments, the media guidance application may use more than one biometric measurement to determine an emotion for the participant. For example, a media guidance application may use biometric measurements of voice volume and blood pressure to determine anger. When a media asset participant has both a loud voice and a high blood pressure, the media guidance application may determine that the participant is angry. The media guidance application will not determine that the media asset participant has a loud voice, but not a high blood pressure. Using multiple biometric measurements to determine emotion may enable the media guidance application to make more accurate determinations.

For example, the media guidance application may receive biometric measurements for a reality television show participant who is in a romantic situation. The media asset participant may be wearing a device that measures the participant's heart rate. The media guidance application may receive the data from the participant's device, and use the heart rate measurement to determine if the participant is excited. The media guidance application may only recommend the media asset to the user if the media asset participant is excited. This allows the user to only watch the reality television show if it contains genuine excitement during a romantic situation, and thus appeals to the user's tastes.

In another example, the media guidance application may receive the biometric measurements for an actor in an action movie, while the actor in the movie is jumping out of a plane during a scene in the movie. The media guidance application may use the heart rate of the actor to make a determination if the actor is feeling excited. If the media guidance application determines that the actor's excitement is genuine, the movie may be recommended to the user. In some embodiments, only the movie scene depicting the actor jumping out of the plane may be recommended to the user.

At step 606, the media guidance application cross-references the biometric measurements with a database listing biometric measurements for non-participants experiencing the emotion to determine whether the biometric measurement corresponds to the biometric measurements for non-participants experiencing the emotion. The database may be stored using the storage circuitry 308. The cross-referencing may be performed using processing circuitry 306. The cross-referencing may comprise an averaging step, a calculated deviation and a threshold as described above.

In some embodiments, the database may comprise data structures that associate a unique non-participant identifier with many biometric measurements taken from that non-participant at a single instant. Each non-participant in the database has its own identifier, which may be a name, number or alphanumeric combination. The information stored in the database may come from wireless devices 406 belonging to the users of the database. The information stored in the database may also come from places like research labs or hospitals that collect many biometric measurements. The database may also associate the unique non-participant identifier with metadata about the non-participant, for example, the non-participant's demographic data or relationship to the user. The database information may be filtered using the non-participant identifiers, the non-participant metadata, or a subset of biometric measurements. For example, the database may be filtered to only output blood pressure and height belonging to non-participants over 40 who are in the user's cell phone contacts list. The database will output a listing with the desired characteristics, which the media guidance application can then use for the cross-referencing step 606.

In some embodiments, the media guidance application may cross-reference a plurality of non-participant biometric measurements with a plurality of participant biometric measurements. For example, the media guidance application may receive biometric measurements for two competitors on a singing competition television show, where one competitor sings a sad song and the other competitor sings a happy song. The media guidance application may cross-reference the sad song's singer with a subset of non-participants whose biometric measurements are associated with the emotion of sadness. The media guidance application may also cross-reference the happy song's singer with a subset of non-participants whose biometric measurements are associated with the emotion of happiness. The media guidance application's final recommendation will be based on the results of both the cross-referencing steps, and may only recommend the television show if both singers display genuine emotion.

In some embodiments, the database may comprise data structures that associate a non-participant's biometric measurements with a situation identifier. The situation identifiers allow the media guidance application to compare the media asset participant's biometric measurements to only those non-participants who were in a similar situation when the non-participants' biometric measurements were taken. The situation identifier may provide information about what emotion the non-participant was experiencing when the biometric measurements were taken. The emotion data may be received from the non-participant through an input mechanism. For example, the database may store information that indicates a user's measurements taken on Tuesday morning are associated with the emotion of anger, as the user typed “angry” into an application on their mobile device on Tuesday morning. The situation identifier may also comprise information about an event taking place when the non-participant's biometric measurements were taken. For example, the database may store information that a non-participant was watching a football game when Sunday night measurements were taken, based on the non-participant's mobile device's GPS data indicating that the user was in a sports stadium on Sunday night.

In some embodiments, the biometric measurements of the non-participants may be selected in response to determining that the non-participants' situation identifier indicates they are experiencing a similar emotion or event as the media asset participant. For example, the media guidance application may determine that a media asset participant is angry based on the tags associated with the media asset participant's biometric measurements. In response to this determination, the media asset application may retrieve from the database only those non-participant biometric measurements whose situation identifiers indicate they were angry when the measurements were taken. This will cause the media guidance application to compare participant and non-participant measurements for the same emotion. In another example, the media guidance application may determine using broadcast data that incoming media asset participants' biometric measurements were taken during a game of football. In response to this determination, the media guidance application may retrieve from the database only those non-participant biometric measurements whose situation identifiers indicate they were watching football when the measurement was taken.

In some embodiments, the user may be sending biometric measurements to the database while the media guidance system is performing the cross-referencing step 606. For example, a wireless user communications device 406 may send the user's biometric measurements to the media guidance application through the communications network 414. Therefore, the media guidance application may be able to cross-reference the biometric measurements for the participant with the current biometric measurements of the user, and provide a recommendation of a media asset that has participants whose biometric measurements correspond to the current biometric measurements of the user.

At step 608, the media guidance application recommends the media asset to the user in response to determining that the biometric measurement corresponds to the biometric measurements for non-participants during the emotion. The recommendation may include generating an indicator, as described earlier in reference to element 504, giving the recommendation, or automatically presenting the recommended media asset to the user. The indication may be displayed to the user on user television equipment 402. The recommendation may also include generating an indicator for an external device, for example 404 or 406, associated with the user. For example, a user not currently watching television may get a text message from the media guidance application informing the user that she might enjoy a movie currently playing on the television.

FIG. 7 is a flowchart of illustrative steps for generating a recommendation of a media asset based on the emotional display authenticity and intensity in accordance with some embodiments of the disclosure. FIG. 7 shows one possible embodiment of the process shown in FIG. 6. It should be noted that the process 700 or any step thereof could be performed on, or provided by, any of the devices shown in FIGS. 3 and 4. For example, process 700 may be executed by control circuitry 304 as instructed by the media guidance application or a module thereof in order to provide media asset recommendations. In addition, one or more steps of process 700 may be incorporated into or combined with one or more steps of any other process or embodiment.

At step 702, the media guidance application initiates process 700. The media guidance application monitors the media asset participant for an emotional display. In some embodiments, the media asset application may continuously receive the participant's biometric measurements, through communications network 414, and use the control circuitry to determine which emotion corresponds best to the biometric measurements. If the biometric measurements do not correspond to an emotional display known to the media guidance application (i.e., the emotional display cannot be found in the storage circuitry 308 associated with the media guidance application), then the media guidance application will continue receiving further biometric measurements.

In step 704, the media guidance application determines, using control circuitry 304, whether an emotional display has been detected. As long as an emotional display has not been detected, the media guidance application will keep returning to step 702. When an emotional display is detected, the media guidance application will proceed to step 706. For example, in a movie, for as long as a current scene displays a landscape, the media guidance application will not proceed to step 706. When an actor is detected on screen and the actor's biometric measurements correspond to an emotional display, the media guidance application will proceed to step 706.

In step 706, the media guidance application determines, using control circuitry 304, if the emotional display is authentic. In some embodiments, deviation between the biometric measurements for the participant and the average biometric measurements for non-participants may be calculated to make this determination. For example, the biometric measurements for the participant may be compared to the biometric measurements for non-participants, and the emotional display considered authentic if the deviation between the two sets of biometric measurements is negligible. If the emotional display is not determined to be authentic, the media guidance application proceeds to step 714 and the media asset is not recommended to the user. If the emotional display is determined to be authentic, the media guidance application proceeds to step 708.

In step 708, the media guidance application determines, using control circuitry 304, if the media asset recommendation is based on the intensity of emotional display. For example, the user may only want to be recommended media assets that have a high degree of emotion present, to gain maximum entertainment. In some embodiments, the user may be able to access a setting in the media guidance application that allows the user to select whether media asset recommendations should take into account the intensity of emotional displays. As referred to herein, “access a setting” may include accessing a graphical display comprising selectable options, accessing a voice-activated system comprising selectable options, or any method of storing a preference in storage circuitry 308.

If the media guidance recommendation is based on intensity of emotional display, the media guidance application proceeds to step 710. If the media guidance recommendation is not based on the intensity of emotional display, the media guidance system proceeds to step 718.

In step 710, the media guidance application determines, using control circuitry 304, the intensity of the emotional display. In some embodiments, the media guidance application may compare the biometric measurements of the participant to the biometric measurements of non-participants during a similar emotional display to determine the intensity. For example, if the participant is crying in a display of sadness, and the biometric measurements of non-participants indicate the non-participants would only tear up in sadness during a similar emotional display, the emotional display would be determined to be very intense.

In step 712, the media guidance application makes a determination, using control circuitry 304, of whether there exists an intensity conflict with the parental control settings. For example, the user may access a setting to set the parental control settings, which might dictate that only media assets with an intensity of “moderate” or lower should be recommended. The current participant's biometric measurements may indicate that the participant is experiencing an “intense” emotion. In this case, the media guidance application would not recommend the media asset containing the participant. If there is an intensity conflict, the media guidance application proceeds to step 714. If there is no intensity conflict, the media guidance application proceeds to step 716.

In step 714, the media asset is not recommended. In some embodiments, the media guidance application may do nothing and let the user continue her actions. In some embodiments, the media guidance application may actively dissuade the user from accessing the media asset by generating an indicator or preventing user access to the media asset. For example, the media guidance application may generate an indicator in the form of a text message or an overlay that informs the user that the user would not enjoy a movie currently playing on a certain broadcast channel. This indicator may be displayed on user television equipment 402, user computer equipment 404 or wireless user communications device 406. In another example, the media guidance application may block a certain website or cancel a television recording upon determining a certain website or television show should not be recommended.

In step 716, the media guidance application determines, using control circuitry 304, if the intensity exceeds a threshold intensity. Since the media guidance application is recommending media assets based on the intensity of the emotional displays, it may set a threshold for the level of intensity that the emotional displays must exceed for the corresponding media asset to be recommended. This step may comprise a comparison between the determined intensity of the emotional display and a threshold intensity. In some embodiments, the user may be able to access a setting to create or modify the threshold intensity.

In step 718, the media guidance system recommends the media asset. This step may be similar to step 608.

The above-described embodiments of the present disclosure are presented for the purposes of illustration and not of limitation, and the present disclosure is limited only by the claims that follow. Furthermore, it should be noted that features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems or methods described above may be applied to, or used in accordance with, other systems or methods.

It should be understood that the above steps of the flow diagrams of FIGS. 6-7 may be executed or performed in any order or sequence not limited to the order and sequence shown and described in the figures. Also, some of the above steps of the flow diagrams of FIGS. 6-7 may be executed or performed substantially simultaneously, where appropriate.

1. A method for recommending media assets, the method comprising:
receiving a biometric measurement for a media asset participant during an emotional display of the participant in a media asset;
determining an emotion corresponding to the emotional display;
cross-referencing the biometric measurement with a database listing biometric measurements for non-participants experiencing the emotion to determine whether the biometric measurement corresponds to the biometric measurements for non-participants experiencing the emotion; and
in response to determining that the biometric measurement corresponds to the biometric measurements for non-participants during the emotion, recommending the media asset to a user.

2. The method of claim 1, wherein the media asset participant is a contestant in a reality television show.

3. The method of claim 1, wherein the non-participants are not contestants in a reality television show.

4. The method of claim 1, wherein the biometric measurements for non-participants experiencing the emotion comprise biometric measurements of non-participants in a similar situation.

5. The method of claim 1, further comprising, in response to determining that the biometric measurement does not correspond to the biometric measurements for the non-participants experiencing the emotion, not recommending the media asset to the user.

6. The method of claim 1, wherein the biometric measurements for non-participants experiencing the emotion comprise past biometric measurements for the participant while the participant was experiencing the emotion.

7. The method of claim 1, wherein the determination that the biometric measurement corresponds to the biometric measurements for non-participants experiencing the emotion comprises:
averaging the biometric measurements for the non-participants experiencing the emotion to determine an average non-participant biometric measurement;
determining a deviation between the biometric measurement and the average non-participant biometric measurement; and
comparing the deviation to a threshold deviation to determine whether the biometric measurement corresponds to the biometric measurements for non-participants experiencing the emotion.

8. The method of claim 1, further comprising:
determining an intensity of the emotional display; and
ranking the media asset based on the intensity.

9. The method of claim 1, further comprising setting a parental control lock on the media asset based on the biometric measurement.

10. The method of claim 1, further comprising generating for display an indication of the biometric measurement.

11. A system for recommending media assets, the system comprising:
storage circuitry configured to store a database listing biometric measurements for non-participants; and
control circuitry configured to:
receive a biometric measurement for a media asset participant during an emotional display of the participant in a media asset;
determine an emotion corresponding to the emotional display;
cross-reference the biometric measurement with the database listing biometric measurements for non-participants experiencing the emotion to determine whether the biometric measurement corresponds to the biometric measurements for non-participants experiencing the emotion; and
in response to determining that the biometric measurement corresponds to the biometric measurements for non-participants during the emotion, recommend the media asset to a user.

12. The system of claim 11, wherein the media asset participant is a contestant in a reality television show.

13. The system of claim 11, wherein the non-participants are not contestants in a reality television show.

14. The system of claim 11, wherein the biometric measurements for non-participants experiencing the emotion comprise biometric measurements of the user while the user was experiencing the emotion.

15. The system of claim 11, wherein the control circuitry is further configured to, in response to determining that the biometric measurement does not correspond to the biometric measurements for the non-participants experiencing the emotion, not recommend the media asset to the user.

16. The system of claim 11, wherein the biometric measurements for non-participants experiencing the emotion comprise past biometric measurements for the participant while the participant was experiencing the emotion.

17. The system of claim 11, wherein the control circuitry configured to determine that the biometric measurement corresponds to the biometric measurements for non-participants experiencing the emotion is further configured to:
average the biometric measurements for the non-participants experiencing the emotion to determine an average non-participant biometric measurement;
determine a deviation between the biometric measurement and the average non-participant biometric measurement; and
compare the deviation to a threshold deviation to determine whether the biometric measurement corresponds to the biometric measurements for non-participants experiencing the emotion.

18. The system of claim 11, wherein the control circuitry is further configured to:
determine an intensity of the emotional display; and
rank the media asset based on the intensity.

19. The system of claim 11, wherein the control circuitry is further configured to set a parental control lock on the media asset based on the biometric measurement.

20. The system of claim 11, wherein the control circuitry is further configured to generate for display an indication of the biometric measurement.

21-50. (canceled)
